(19) United States
(12) Patent Application Publication
(10) Pub. No.: US 2026/0266429 A1
(43) Pub. Date: Sep. 10, 2026

(54) METHOD FOR REFILLING A HYDROGEN TANK

(71) Applicant: MAXIMATOR GMBH, Nordhausen (DE)

(72) Inventors: Michael ADLER, Margarethen am Moos (AT); Christoph NAGL, Wien (AT); Robert ADLER, Wien (AT); Markus RASCH, Wien (AT); Markus STEPHAN, Wien (AT)

(21) Appl. No.: 19/166,408

(22) PCT Filed: Mar. 15, 2024
(86) PCT No.: PCT/EP2024/056940

§ 371 Date: Sep. 17, 2025

(30) Foreign Application Priority Data
Mar. 17, 2023 (EP) 23162587.2

(51) Int. Cl. F17C 5/00

(52) U.S. Cl. CPC F17C 5/007; F17C 2205/0326; F17C 2221/012; F17C 2223/036; F17C 2227/0135; F17C 2227/0337; F17C 2265/065; F17C 2270/0168

(57) ABSTRACT

A method for refueling a hydrogen tank, in particular a hydrogen tank belonging to a vehicle, with a gas, in particular hydrogen, comprising the steps of: filling a first hydrogen reservoir with the gas, filling a working fluid reservoir with a working fluid, connecting the first hydrogen reservoir to the hydrogen tank so that gas is transferred from the first hydrogen reservoir to the hydrogen tank, and connecting the working fluid reservoir to the first hydrogen reservoir so that working fluid is transferred from the working fluid reservoir to the first hydrogen reservoir, cooling the gas in the first hydrogen reservoir by isentropic expansion before transferring the working fluid from the working fluid reservoir to the first hydrogen reservoir, so that gas cooled by the isentropic expansion is transferred from the first hydrogen reservoir to the hydrogen tank.

### CROSS REFERENCE TO RELATED APPLICATIONS

The present application is a U.S. National Phase of International Application No. PCT/EP2024/056940 entitled “METHOD FOR REFILLING A HYDROGEN TANK”, and filed on Mar. 15, 2024. International Application No. PCT/EP2024/056940 claims priority to European Patent Application No. 23162587.2 filed on Mar. 17, 2023. The entire contents of each of the above-listed applications are hereby incorporated by reference for all purposes.

### TECHNICAL FIELD

The invention relates to a method for refueling a hydrogen tank, in particular a hydrogen tank belonging to a vehicle, with hydrogen, comprising the steps of:
providing a first hydrogen reservoir with a hydrogen-filled hydrogen volume,
providing a working fluid reservoir with a working fluid,
connecting the first hydrogen reservoir to the hydrogen tank so that hydrogen is transferred from the first hydrogen reservoir to the hydrogen tank in a first outflow phase, and
connecting the working fluid reservoir to the first hydrogen reservoir so that working fluid is transferred from the working fluid reservoir to the first hydrogen reservoir in a first post-compression phase temporally overlapping with the first outflow phase, thereby reducing the hydrogen-filled hydrogen volume in the first hydrogen reservoir and increasing a working fluid volume filled with working fluid in the first hydrogen reservoir.

### BACKGROUND AND SUMMARY

The invention further relates to a refueling system, in particular a mobile refueling system, for refueling a hydrogen tank, in particular a hydrogen tank belonging to a vehicle, with hydrogen, comprising:
a first hydrogen reservoir containing the hydrogen,
a working fluid reservoir containing a working fluid,
a control device, in particular having a valve controller, for controlling a first ejection connection for ejecting hydrogen from the first hydrogen reservoir to the hydrogen tank and for controlling an inflow connection between the working fluid reservoir and the first hydrogen reservoir,
   a pump with which working fluid is pumped from the working fluid reservoir to the first hydrogen reservoir.

Finally, the invention relates to a tank vehicle with such a, preferably mobile, i.e. non-localized, refueling system.

WO 2021/191636 A1 discloses a method which is used for transferring and cooling a compressed gas. In this case, a fuel gas, in particular hydrogen (cf. Paragraph 28), is transmitted from a source container to a receiving container. Cooling takes place in an intermediate container. The source container is connected to the intermediate container via a first fluid path, wherein the fluid communication can be interrupted via a valve in order to isolate the intermediate container. The intermediate container contains a positive displacement expander, which can be formed by a fluid column, a piston compressor or another component that is responsible for the expansion of the fluid located there. Via a second fluid path, the intermediate container is connected to the receiving container, which can be the fuel tank of a vehicle or a machine, wherein the fluid communication can also be interrupted via a valve.

In this prior art, the transmission and cooling of the fuel gas is carried out in three phases.

In the first phase, the source container is brought into fluid communication with the intermediate container, which is completely filled with fluid at this time, by opening the valve. The fuel gas now flows into the intermediate container and displaces the fluid there, which leaves the intermediate container via a valve. During the first phase, the pressure in the source container and in the intermediate container is substantially the same. Due to the expansion of the fuel gas into the intermediate container, the fuel gas cools down in the source container and in the intermediate container. Once a sufficient amount of fuel gas has been transferred to the intermediate container, the inlet valve is closed to separate the intermediate container from the source container.

In the second phase, the complete fluid is withdrawn from the intermediate container via a valve. As a result, an isentropic expansion takes place, as a result of which the fuel gas cools down.

In the third phase, a valve is opened to bring the intermediate container and the receiving container into fluid communication with each other. Since the same pressure prevails in the intermediate container and receiving container, it is necessary to push the cooled fuel into the receiving container by introducing fluid into the intermediate container. In this phase, no more cooling of the hydrogen takes place.

Thus, this method has differences from the invention described below.

In the invention described below, the cooling of the hydrogen occurs during the transfer of hydrogen from the first hydrogen reservoir to the hydrogen tank, depending on the embodiment before and/or during the post-compression phase in which working fluid is pumped from the working fluid reservoir to the first hydrogen reservoir. According to the invention, the cooling can occur due to the partial pressure equalization between the first hydrogen reservoir and the hydrogen tank. Depending on the version, the cooling can also be continued during the post-compression phase. In WO 2021/191636 A1, on the other hand, the hydrogen is cooled exclusively before being transferred to the receiving container. According to WO 2021/191636 A1, no cooling takes place during the transfer of the hydrogen into the receiving container. According to the invention, the working fluid is not used for the expansion of the hydrogen, but for post-compression in the first hydrogen reservoir. Furthermore, the invention preferably does not provide an intermediate container.

DE 10 2015 016327 A1 describes a fueling station for filling storage containers in mobile vehicles with a gas, in particular with hydrogen. The hydrogen is stored in one or more constant pressure reservoirs, with which the gas is made available at a certain, constant pressure. For this purpose, the constant pressure reservoir has a cylinder, which is divided into two regions by a movable separating piston. The first area absorbs the hydrogen. The second region receives a fluid, for example, a hydraulic fluid. During the injection phase, the pressure of the hydrogen in the first region is kept constant by displacing the separating piston, wherein the first region is enlarged and the second region is reduced. During the ejection phase, the volume of the first area is reduced by pumping more liquid into the second area and increasing the volume of the second area so that the pressure in the first area is kept constant. This version is intended to reduce the number of load changes and thereby increase the service life of the fueling station. A disadvantage of this prior art, however, is that an elaborate gas conditioning unit is required with which the gas from the constant-pressure reservoir is prepared for the consumer. In practice, it has been found, in particular, that the temperature of the gas from the constant pressure reservoir had to be lowered with a cooling unit in order not to exceed the permitted maximum temperature of the vehicle tank.

The object of the present invention is to alleviate or eliminate at least individual disadvantages of the prior art. The object of the invention is preferably to provide a method for refueling a hydrogen tank, with which overheating of the hydrogen tank is prevented with the least possible technical complexity.

This object is achieved by a method, a refueling system, and a refueling vehicle having the features as described herein.

According to the invention, the method comprises the following step:
cooling the hydrogen in the first hydrogen reservoir by isentropic expansion before the post-compression phase and/or during the post-compression phase, so that hydrogen cooled by the isentropic expansion is transferred from the first hydrogen reservoir to the hydrogen tank.

When the first hydrogen reservoir is connected to the hydrogen tank, particularly by opening a first gas outlet valve, hydrogen flows from the first hydrogen reservoir into the hydrogen tank due to the pressure difference between the first hydrogen reservoir and the hydrogen tank. A (partial) pressure equalization takes place between the first hydrogen reservoir and the hydrogen tank. By replenishing the working fluid other than hydrogen, here referred to as working fluid, from the working fluid reservoir into the first hydrogen reservoir over the duration of the post-compression phase, the hydrogen in the first hydrogen reservoir is post-compressed. As a result, the mass flow of the hydrogen from the first hydrogen reservoir into the hydrogen tank is increased relative to a free overflow of the hydrogen solely by the pressure difference between the first hydrogen reservoir and the hydrogen tank. Unlike in the prior art, however, the first hydrogen reservoir is not operated as a constant pressure reservoir, but the gas pressure of the hydrogen in the first hydrogen reservoir is reduced before the post-compression phase and/or during the post-compression phase, preferably over the entire duration of the post-compression phase. The hydrogen tank heats up due to the pressure increase when refueling with the hydrogen. In the state of the art with refueling via constant pressure reservoirs, it was only possible by special measures, in particular a cooling unit, not to exceed the maximum temperature of the vehicle tank, which can be between 80° C. and 115° C. In contrast, in the method according to the invention, the at least partially isentropic expansion of the hydrogen in the first hydrogen reservoir causes a cooling of the hydrogen in the first hydrogen reservoir. As a result, after the start of refueling, cooled hydrogen is increasingly transferred from the first hydrogen reservoir to the hydrogen tank due to the isentropic expansion. This has the advantageous effect that the tank temperature rises less sharply over the refueling cycle. The invention therefore makes use of the isentropic expansion of the hydrogen in the first hydrogen reservoir in order to be able to maintain the maximum temperature of the vehicle tank at the end of refueling.

In a first embodiment, the connection of the working fluid reservoir to the first hydrogen reservoir is substantially opened substantially simultaneously with the connection of the first hydrogen reservoir to the hydrogen tank. In this embodiment, the first post-compression phase begins substantially simultaneously with the first outflow phase, in which the hydrogen flows from the first hydrogen reservoir into the hydrogen tank. However, the volumetric delivery of the pump is not sufficient to maintain the pressure in the first hydrogen reservoir, so that partially isentropically expanded hydrogen is transferred from the first hydrogen reservoir to the hydrogen tank during the post-compression phase. The first post-compression phase may end before, simultaneously with, or after the end of the first outflow phase (i.e., before, simultaneously with, or after the connection between the first hydrogen reservoir and the hydrogen tank is closed).

In a particularly preferred embodiment, the first outflow phase begins before the first post-compression phase, i.e. the connection between the working fluid reservoir and the first hydrogen reservoir is only opened after a waiting time has elapsed from the beginning of the first outflow phase. Thus, cooling of the hydrogen in the first hydrogen reservoir by isentropic expansion prior to transferring the working fluid from the working fluid reservoir to the first hydrogen reservoir begins.

By observing the waiting time before opening a first inflow connection to the working fluid reservoir, various effects can be achieved.

Even a waiting time of at least 5 seconds, in particular of at least 10 seconds, for example of at least 20 seconds, alleviates or solves the problem that the first ejection connection, for example a pipeline, has a thermal capacity between the first hydrogen reservoir and the hydrogen tank and must first be cooled, which is caused by the hydrogen flowing out. To maximize the effect of the pressure ratio between the first hydrogen reservoir and the hydrogen tank, it is advantageous to start the first post-compression phase first (i.e., to start the pump and reduce the pressure drop by displacing the hydrogen in the first hydrogen reservoir with working fluid, thereby reducing the absolute temperature difference between the hydrogen in the first hydrogen reservoir and the hydrogen in the hydrogen tank) when the first ejection connection has been pre-cooled.

On the other hand, with a longer waiting time of at least 30 seconds, in particular of at least 60 seconds, the cooling effect due to the pressure difference between the first hydrogen reservoir and the hydrogen tank can be used even more strongly.

In these embodiments, the hydrogen in the first hydrogen reservoir is already cooled before the start of the first post-compression phase due to the isentropic expansion, so that cooled hydrogen flows from the first hydrogen reservoir into the hydrogen tank. This cooling effect counteracts the heating by increasing the pressure in the hydrogen tank. After the waiting time has elapsed, the working fluid is conveyed into the first hydrogen reservoir designed as a pressure reservoir, as a result of which the hydrogen volume available for the hydrogen in the first hydrogen reservoir is reduced. Therein, the volumetric delivery rate of the (high-pressure) pump is not sufficient to maintain the pressure in the first hydrogen reservoir. In a preferred embodiment, the first ejection connection is closed into the first hydrogen reservoir, preferably when the working fluid continues to flow, as soon as the vehicle tank and the first hydrogen reservoir have adjusted their pressures to a pressure difference preferably selected from a range of 20 bar to 200 bar, preferably 30 bar to 100 bar, in particular from 40 bar to 70 bar, so that the first outflow phase from the first hydrogen reservoir is terminated.

The replenishing of the cooled gas counteracts the temperature increase of the hydrogen tank, which results from the pressure increase when refueling with the gas. Advantageously, the final temperature of the hydrogen tank can thus be lowered at the end of the refueling process. It is particularly favorable if the final temperature of the hydrogen tank can be kept below a predetermined maximum temperature without additionally having to cool the gas flowing out of the first hydrogen reservoir (or from the second or third hydrogen reservoir described further below). This makes it possible, in particular, to dispense with a cooling unit between the first hydrogen reservoir and the hydrogen tank. Thus, preferably no cooling unit is connected between the first hydrogen reservoir and the hydrogen tank (and optionally also no cooling unit is connected between the second hydrogen reservoir and the hydrogen tank or between the third hydrogen reservoir and the hydrogen tank, see below).

For purposes of this disclosure, “hydrogen” always refers to molecular hydrogen (H2).

With the method according to the invention, in particular the hydrogen tank of a vehicle with a fuel cell, for example a construction vehicle such as an excavator, can be refueled with hydrogen.

When opening the first inflow connection to the working fluid reservoir after the waiting time has elapsed, the gas remaining in the first hydrogen reservoir may have a temperature of less than minus 20 degrees Celsius (° C.), in particular less than minus 30 degrees Celsius, for example less than minus 35° C.

Preferably, the initial pressure of the hydrogen in the first hydrogen reservoir, i.e. the nominal pressure of the hydrogen before the opening of the first ejection connection to the hydrogen tank, is more than 500 bar, preferably more than 600 bar, in particular more than 700 bar and/or less than 875 bar, for example, substantially 800 bar. The same preferably also applies to the second hydrogen reservoir described below and to the third hydrogen reservoir described below, respectively.

In practice, polytropic expansion of the hydrogen takes place in the first hydrogen reservoir (and, of course, also in the second or third hydrogen reservoir described further below). When isentropic expansion is mentioned in this description, the isentropic portion of the polytropic expansion due to the opening of the first ejection connection from the first (to nth) hydrogen reservoir to the hydrogen tank is to be understood.

In a preferred embodiment, when the first ejection connection is open, the gas is conveyed from the first pressure reservoir to the hydrogen tank solely on the basis of the pressure difference between the first hydrogen reservoir and the hydrogen tank, i.e. passively, without an additional compressor.

In the refueling system according to the invention, the control device is configured to control the first inflow connection and/or the pump in such a way that hydrogen in the first hydrogen reservoir is cooled by isentropic expansion and hydrogen cooled by the isentropic expansion is discharged from the first hydrogen reservoir via the first ejection connection into the hydrogen tank.

In a preferred embodiment, the control device is configured to open the first inflow connection after a waiting time has elapsed from the connection of the first hydrogen reservoir to the hydrogen tank.

In order to give the gas in the first pressure reservoir sufficient time for the isentropic expansion, in a preferred embodiment, a waiting time of at least 5 seconds, in particular at least 10 seconds, preferably at least 15 seconds, from the time of connecting the first hydrogen reservoir to the hydrogen tank to the time of connecting the working fluid reservoir to the first hydrogen reservoir is maintained with the control device. With this embodiment, the first ejection connection can be cooled using the maximum pressure difference between the first hydrogen reservoir and the hydrogen tank.

In order to ensure that hydrogen is ejected from the first hydrogen reservoir into the hydrogen tank in the more strongly isentropically cooled state, the waiting time may be at least 30 seconds, in particular at least 60 seconds.

Depending on the embodiment, the waiting time may be less than 15 minutes, in particular less than 10 minutes, preferably less than 5 minutes.

In a preferred embodiment, the working fluid in the first hydrogen reservoir is in direct contact with the hydrogen. The working fluid is therefore designed as a liquid piston. The working fluid thus forms a liquid volume, in particular a liquid column, in the interior of the first hydrogen reservoir, which directly adjoins the hydrogen, i.e. without intermediate machine components, in particular without a solid-state piston. By replenishing working fluid into the first hydrogen reservoir, the working fluid volume occupied by the working fluid inside the first hydrogen reservoir is increased and the hydrogen volume occupied by the hydrogen is reduced, which is associated with a corresponding increase in the hydrogen pressure.

A polyalphaolefin is preferably used as the working fluid.

The use of a polyalphaolefin (PAO) as a working fluid is surprising, as special advantages are achieved without having to accept the disadvantages typical of PAO.

Practical tests have shown that a particular advantage of the PAO for the application according to the invention is its thin liquid, i.e. its low viscosity. This can, for example, avoid the problem that gases dissolved in the fluid as a result of pressure changes lead to foaming of the fluid during re-expansion. Such foaming could, for example, increase the cavitation tendency in a pump replenishing the working fluid, which would increase the wear of the pump. When refueling the vehicle with hydrogen, foaming of the working fluid could further cause fluid carryovers into the hydrogen tank, which, however, should be avoided. In the prior art, highly viscous working fluids, for example ionic liquids, have been proposed which have a high tendency to foam, which should be compensated by a very low gas solubility. In fact, however, the required low gas solubility was not achieved in practice. Other working fluids such as mineral oils, synthetic oils and hydraulic oils are so viscous that foam formation would make use in the applications according to the invention very disadvantageous or impossible. On the other hand, thermal oils are unsuitable for use in systems that provide hydrogen for fuel cell-powered vehicles due to their tendency to carry over. The use of the PAO according to the invention is based on the finding that with the low tendency of the PAO to foam, foam formation can be reliably avoided without requiring an extremely low gas solubility. In the applications according to the invention, the low foaming of the PAO can be used optimally, even if the gas solubility of the PAO is quite low in absolute terms, but higher than in the case of the ionic liquids.

A “polyalphaolefin” is understood to mean a poly-1-olefin which has been prepared by polymerization of alphaolefins. The term “polyalphaolefin” includes polyalphaolefin homopolymers, polymers composed of two or more different monomer units (e.g., polyalphaolefin copolymers, polyalphaolefin terpolymers), and mixtures thereof.

The working fluid preferably comprises the polyalphaolefin in an amount of 80% by weight or more, more preferably 90% by weight or more, even more preferably 95% by weight or more, particularly preferably 99% by weight or more, based on the total weight of the working fluid. As a result, the positive properties of the polyalphaolefin with regard to low gas solubility and low tendency to foam can be used effectively.

Depending on the design, the working fluid may have exactly one polyalphaolefin. In a preferred embodiment, the working fluid comprises a mixture of two or more polyalphaolefins. The physical properties of the working fluid (e.g. viscosity, boiling point) can then be adapted to the respective conditions.

The polyalphaolefin may have an unbranched or a branched chain structure (n-alkane or iso-alkane). A mixture of an unbranched polyalphaolefin and an isomer of the same polyalphaolefin or a polyalphaolefin having a different number of carbon atoms may also be used. This allows the boiling point of the working fluid to be adjusted.

In a preferred embodiment, at least 90% by weight of the polyalphaolefin has 19 or fewer carbon atoms per molecule, preferably 14 to 18 carbon atoms per molecule, more preferably 16 to 18 carbon atoms per molecule, based on the total weight of the polyalphaolefin. Preferably, at least 95% by weight of the polyalphaolefin has such a number of carbon atoms, more preferably at least 99% by weight, based on the total weight of the polyalphaolefin. Polyalphaolefins with such a number of carbon atoms have a particularly low gas solubility and a particularly low tendency to foam, so that they are well suited as a working fluid. If the working fluid has two or more polyalphaolefins, preferably all polyalphaolefins have such a number of carbon atoms.

Preferably, a maximum of 10% by weight of the polyalphaolefin has 20 or more carbon atoms, in particular 20 to 30 carbon atoms, based on the total weight of the polyalphaolefin. Preferably, a maximum of 5% by weight of the polyalphaolefin has such a number of carbon atoms, more preferably a maximum of 3% by weight, based on the total weight of the polyalphaolefin. As a result, the viscosity can be kept low, which is associated with a low tendency to foam.

The working fluid preferably has a content of an aromatic hydrocarbon of at most 1% by weight, preferably at most 0.5% by weight, based on the total weight of the working fluid. This also allows the viscosity and consequently the tendency to foam to be kept low.

A content of a sulfur compound in the working fluid is preferably at most 10,000 ppm, more preferably at most 1,000 ppm, based on the total weight of the working fluid. This makes it possible, in particular, to avoid an effect as a cellular poison in vehicles with fuel cell drive.

In a preferred embodiment, the hydrogen is present in the first hydrogen reservoir prior to connection to the hydrogen tank at a nominal pressure, also referred to as the initial pressure. The nominal pressure is preferably more than 500 bar, preferably more than 600 bar, in particular more than 700 bar, and/or less than 875 bar, for example substantially 800 bar. At the conclusion of the refueling process, the hydrogen may be recompressed substantially to the nominal pressure by connecting the first (and/or the second or third) hydrogen reservoir to the working fluid reservoir, as described below.

In order to achieve high filling pressures in the hydrogen tank by sequential refueling of the hydrogen tank via several hydrogen reservoirs, the method in a preferred embodiment also has the following steps:
providing a second hydrogen reservoir with a second hydrogen-filled hydrogen volume,
connecting the second hydrogen reservoir to the hydrogen tank, preferably with the first ejection connection closed, so that hydrogen is transferred from the second hydrogen reservoir to the hydrogen tank in a second outflow phase,
replenishing of working fluid into the second hydrogen reservoir in a second post-compression phase, preferably by connecting the second hydrogen reservoir to the first hydrogen reservoir and transferring working fluid from the first hydrogen reservoir to the second hydrogen reservoir, so that the hydrogen in the second hydrogen reservoir is cooled by isentropic expansion before the second post-compression phase and/or during the second post-compression phase, and cooled hydrogen is transferred by the isentropic expansion from the second hydrogen reservoir into the hydrogen tank.

The connection between the second hydrogen reservoir and the hydrogen tank is preferably opened 1 to 20, in particular 2 to 10, for example substantially four, minutes after the first hydrogen reservoir is connected to the hydrogen tank, so that hydrogen is discharged from the second hydrogen reservoir in the direction of the hydrogen tank via a second ejection connection.

In order to achieve even higher filling pressures by sequential refueling of the hydrogen tank via several hydrogen reservoirs, the method in a preferred embodiment also has the following steps:
providing a third hydrogen reservoir with a third hydrogen-filled hydrogen volume,
connecting the third hydrogen reservoir to the hydrogen tank, preferably in the closed state of the first and second ejection connections, so that hydrogen is transferred from the third hydrogen reservoir to the hydrogen tank in a third outflow phase,
replenishing of working fluid into the third hydrogen reservoir in a third post-compression phase, preferably by connecting the third hydrogen reservoir to the second hydrogen reservoir and transferring working fluid from the second hydrogen reservoir to the third hydrogen reservoir, so that the hydrogen in the third hydrogen reservoir is cooled by isentropic expansion before the third post-compression phase and/or during the third post-compression phase, and cooled hydrogen is transferred by the isentropic expansion from the third hydrogen reservoir into the hydrogen tank.

The connection between the third hydrogen reservoir and the hydrogen tank is preferably opened 1 to 20, in particular 2 to 10, for example substantially four, minutes after the second hydrogen reservoir is connected to the hydrogen tank, so that hydrogen is discharged from the third hydrogen reservoir in the direction of the hydrogen tank via a third ejection connection.

In order to achieve effective post-compression of the hydrogen in the respective hydrogen reservoir, in a preferred embodiment, the working fluid is pumped by means of a high-pressure pump, in particular an axial piston pump, a radial piston pump, a gear pump or a displacement piston pump, in particular a plunger piston pump, from the working fluid reservoir to the first hydrogen reservoir, preferably also from the first hydrogen reservoir to the second hydrogen reservoir and/or from the second hydrogen reservoir to the third hydrogen reservoir and/or from the third hydrogen reservoir to the working fluid reservoir. With the mentioned embodiments of the high-pressure pump for the working fluid, high hydrogen pressures of more than 500 bar, in particular more than 600 bar, preferably more than 700 bar and/or a maximum of 875 bar, for example substantially 800 bar, can be achieved in the respective hydrogen reservoir.

The pump is preferably coupled to a drive, in particular to a drive motor. The drive provides the drive power with which the high-pressure pump is operated in order to convey the working fluid under pressure into the first hydrogen reservoir, preferably also into the second hydrogen reservoir, in particular also into the third hydrogen reservoir.

In a particularly preferred embodiment, the drive is coupled to a hydraulic connection of the vehicle, so that the drive is operated via the hydraulic connection of the vehicle. Thus, the drive power for the drive can be provided by the vehicle, which has a hydraulic connection for providing hydraulic fluid, preferably at a pressure of 50 to 420, in particular 100 to 300 bar, for example 150 to 250 bar. Such hydraulic connections are present, for example, in construction vehicles. Advantageously, the vehicle to be refueled can thus itself provide the drive power for the operation of the high-pressure pump. As a result, the refueling system itself can be simplified or reduced in size. This advantage is particularly significant in the case of a mobile refueling system, preferably as part of a tank vehicle.

For continuous operation of the high-pressure pump via a hydraulic circuit, it is advantageous if the drive is connected to the hydraulic connection of the vehicle via a bidirectional hydraulic coupling, so that hydraulic fluid at high pressure is supplied to the drive and hydraulic fluid at low pressure is returned from the drive to the hydraulic connection of the vehicle.

In a preferred embodiment, the hydrogen in the hydrogen tank is compressed during refueling to a filling pressure of more than 500 bar, in particular more than 600 bar, preferably more than 650 bar, preferably up to 875 bar. All pressure specifications of this disclosure relate to an ambient temperature of 288.15 Kelvin.

As described above in connection with the method for refueling the hydrogen tank, in a preferred embodiment of the refueling system, a second hydrogen reservoir is provided that is connectable to the hydrogen tank via a second ejection connection. Particularly preferred is an embodiment with a third hydrogen reservoir that is connectable to the hydrogen tank via a third ejection connection. The second and/or the third hydrogen reservoir are preferably identical to the first hydrogen reservoir.

The first and/or the second and/or the third hydrogen reservoir can have a holding volume of 50 to 1000 litres (l), in particular 200 to 500 l, for example substantially 400 l. In the fully filled state, 5 to 130 kilograms (kg) of hydrogen, for example substantially 20 kg of hydrogen, can be stored in the first or second or third hydrogen reservoir.

In order to be able to release and block the above-described gas and working fluid flows at different times, the refueling system has, in a preferred embodiment:
a first gas outlet valve in the first ejection connection, and/or
a second gas outlet valve in the second ejection connection, and/or
a third gas outlet valve in the third ejection connection, and/or
a first inflow valve in the first inflow connection from the working fluid reservoir to the first hydrogen reservoir, and/or
a second inflow valve in the second inflow connection from the working fluid reservoir to the second hydrogen reservoir, and/or
a third inflow valve in the third inflow connection from the working fluid reservoir to the third hydrogen reservoir, and/or
a first gas inlet valve for filling the first pressure reservoir with the hydrogen, and/or
a second gas inlet valve for filling the second pressure reservoir with the hydrogen, and/or
a third gas inlet valve for filling the third pressure reservoir with the hydrogen, and/or
a first return valve in a first return line from the first hydrogen reservoir to the second hydrogen reservoir for transferring working fluid from the first hydrogen reservoir to the second hydrogen reservoir, and/or
a second return valve in a second return line from the second hydrogen reservoir to the third hydrogen reservoir for transferring working fluid from the second hydrogen reservoir to the third hydrogen reservoir, and/or
a third return valve in a third return line from the third hydrogen reservoir to the working fluid reservoir for returning working fluid from the third hydrogen reservoir to the working fluid reservoir.

In a preferred embodiment, the refueling system has, as a high-pressure pump, an axial piston pump, a radial piston pump, a gear pump or a displacement piston pump, in particular a plunger piston pump, with which working fluid can be pumped from the working fluid reservoir to the first hydrogen reservoir, preferably also from the first hydrogen reservoir to the second hydrogen reservoir and/or from the second hydrogen reservoir to the third hydrogen reservoir and/or from the third hydrogen reservoir to the working fluid reservoir.

In a preferred embodiment of the refueling system, the high-pressure pump is coupled to a drive. The drive is preferably coupled to a hydraulic connection of the vehicle. As a result, the drive can be operated via the hydraulic connection of the vehicle, i.e. supplied with drive power. In a preferred embodiment of the refueling system, the drive is connected to the hydraulic connection of the vehicle via a bidirectional hydraulic coupling. As a result, hydraulic fluid at high pressure can be supplied to the drive and hydraulic fluid at low pressure can be returned from the drive to the hydraulic connection of the vehicle.

The invention also relates to a refueling vehicle having a cargo space in which a mobile refueling system is accommodated in one of the above-described embodiments.

In a preferred embodiment, the refueling vehicle provided is a hydrogen vehicle, in particular a fuel cell vehicle, which has a hydrogen vehicle tank with which the energy for the propulsion of the refueling vehicle is provided. It is particularly advantageous if the hydrogen vehicle tank of the refueling vehicle is connected to the first hydrogen reservoir, optionally also to the second and/or third hydrogen reservoir, via a fluid line provided in particular with an openable and closable valve. Thus, the range of the refueling vehicle can be increased by transferring hydrogen from the first, and optionally from the second or third, hydrogen reservoir to the hydrogen vehicle tank of the refueling vehicle. In this embodiment, the refueling vehicle may self-supply with hydrogen as needed. On the other hand, another vehicle can be refueled with hydrogen at the site with the refueling vehicle.

The invention is explained in more detail below with reference to a preferred exemplary embodiment in the drawings.

### BRIEF DESCRIPTION OF THE FIGURES

FIG. 1 schematically shows a mobile refueling system for refueling a hydrogen tank belonging to a vehicle.

FIGS. 2 to 5 show various steps of a method for refueling the hydrogen tank, wherein individual inactive gas and working fluid lines are hidden for the sake of clarity.

FIG. 6 schematically shows several characteristic curves of the method for refueling the hydrogen tank.

### DETAILED DESCRIPTION

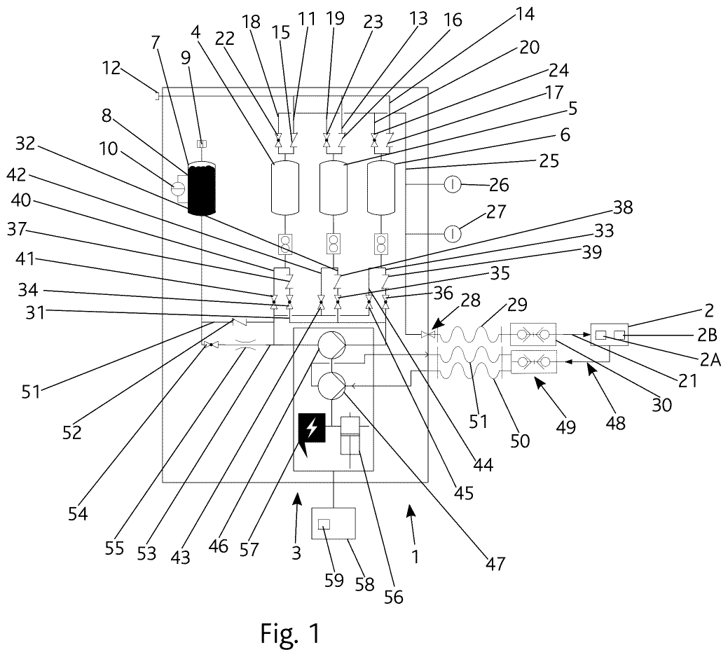

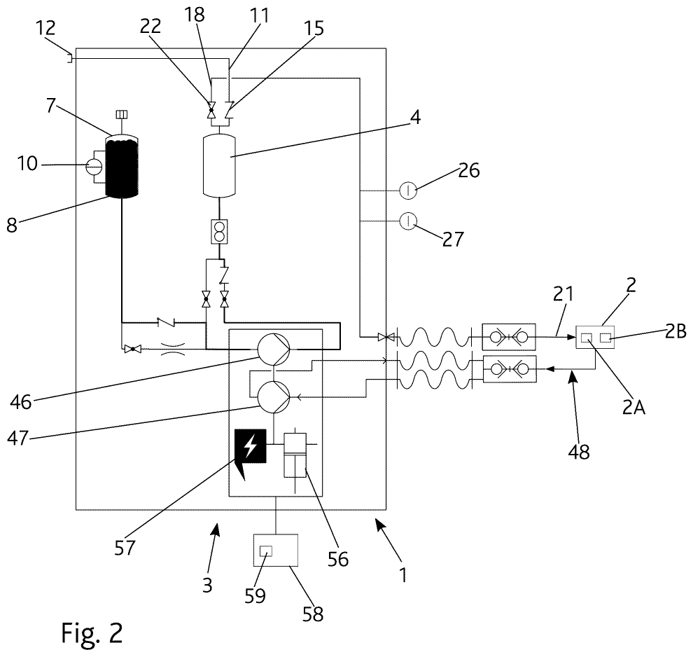

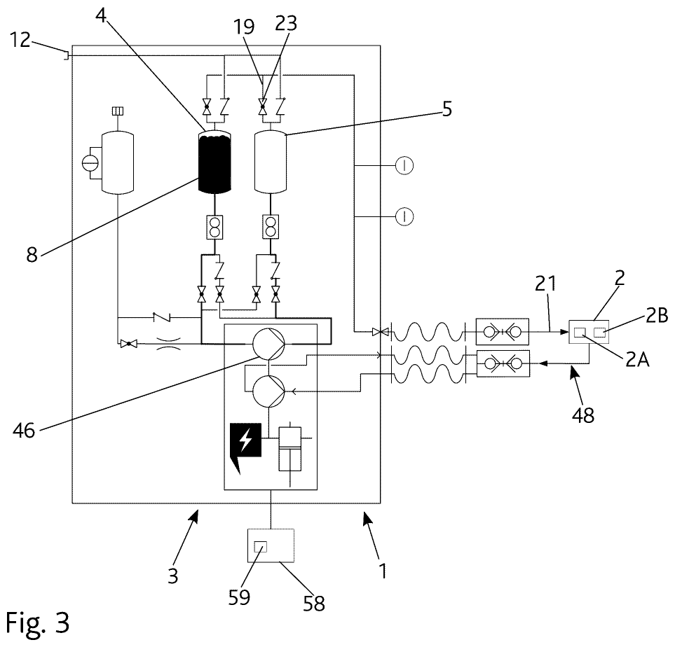

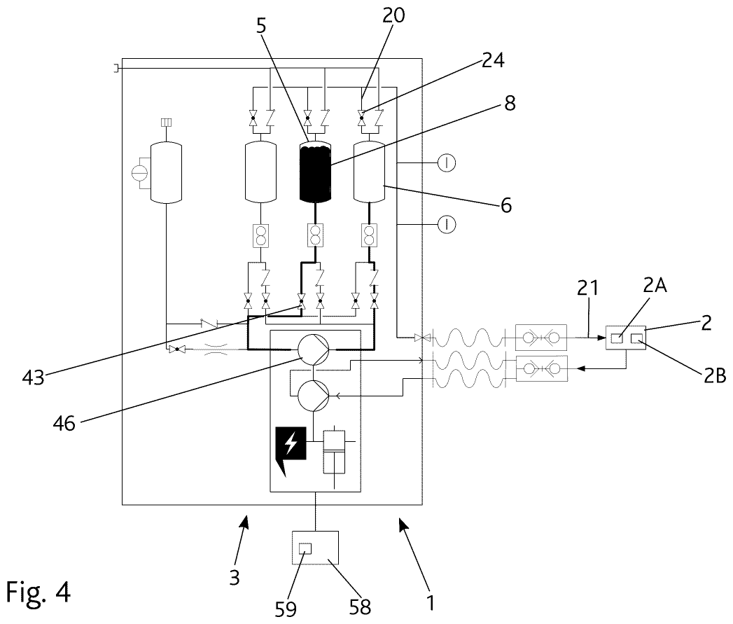

FIG. 1 schematically shows a refueling system 1 for refueling a hydrogen tank 2A (symbolically shown in FIG. 1) belonging to a vehicle 2 with hydrogen. The vehicle 2 to be refueled can have a fuel cell 2B, which is operated with the hydrogen from the hydrogen tank 2A. FIG. 1 shows a mobile version of the refueling system 1, which can be carried in the cargo space of a refueling vehicle 3 (different from the vehicle 2 to be refuelled). The mobile refueling system 1 has a first hydrogen reservoir 4, a second hydrogen reservoir 5, and a third hydrogen reservoir 6, which are each filled with hydrogen, i.e., have a first, second, and third hydrogen volume, respectively. In addition, the refueling system 1 has a working fluid reservoir 7, which is filled with a working fluid 8, in this case polyalphaolefin. The first 4, second 5, and third hydrogen reservoirs 6 and the working fluid reservoir 7 are arranged substantially vertically (i.e., their longitudinal axes extend in the vertical direction). All location and directional indications of this disclosure relate to the intended operating state of the refueling system 1 in the cargo space of the tank vehicle 3 on a horizontal surface. The fill level of the working fluid reservoir 7 is monitored with a fill level measuring element 9. Pressure and temperature of the working fluid reservoir 7 are monitored with a pressure and temperature measuring element 10.

The first hydrogen reservoir 4 is connected to a gas inlet 12 via a first injection connection 11. The second hydrogen reservoir 5 is connected to the gas inlet 12 via a second injection connection 13. The third hydrogen reservoir 6 is connected to the gas inlet 12 via a third injection connection 14. The first injection connection 11 has a first gas inlet valve 15, the second injection connection 13 has a second gas inlet valve 16, and the third injection connection 14 has a third gas inlet valve 17. In the open state of the first 15, second 16, and third gas inlet valve 17, gas provided at the gas inlet 12 is transferred to the first 4, second 5, and third hydrogen reservoir 6, respectively, so that hydrogen is stored at a nominal pressure of, for example, substantially 800 bar in the first 4, second 5, and third hydrogen reservoir 6.

The first 4, second 5 or third hydrogen reservoir 6 is connectable via a first 18, second 19 or third ejection connection 20 to a gas outlet 21, to which the vehicle 2 to be refueled is connectable. A first 22, second 23 and third gas outlet valve 24 are arranged in the first 18, second 19 and third ejection connection 20, respectively. The first 18, second 19 and third ejection connection 20 are combined in a common outlet line 25, in which a temperature measuring element 26 for measuring the gas temperature and a gas pressure measuring element 27 for measuring the gas pressure are arranged. The outlet line 25 is connected to the gas outlet 21 via a fuse 28, a gas line 29, and a tank coupling 30.

The working fluid reservoir 7 has a supply line 51 with a supply valve 52, which is connected to the first hydrogen reservoir 4 via a first inflow connection 31, to the second hydrogen reservoir 5 via a second inflow connection 32, and to the third hydrogen reservoir 6 via a third inflow connection 33. The first 31, second 32 and third inflow connection 33 each open into the underside of the first 4, second 5 and third hydrogen reservoir 6, respectively, so that the first 4, second 5 and third hydrogen reservoir 6 is filled with working fluid 8 from below. A first 34, second 35 and third inflow valve 36 and a first 37, second 38 and third inflow check valve 39 are arranged in each of the first 31, second 32 and third inflow connections 33.

The first hydrogen reservoir 4 is connected via a first return line 40 with a first return valve 41 to the second inflow connection 32, with which the second hydrogen reservoir 5 is supplied with working fluid. The second hydrogen reservoir 5 is connected via a second return line 42 with a second return valve 43 to the third inflow connection 33, with which the third hydrogen reservoir 6 is supplied with working fluid. The third hydrogen reservoir 6 is connected via a third return line 44 with a third return valve 45 to a return line 53, which runs parallel to the supply line 51. A return valve 54 and an orifice 55 are arranged in the return line 53. The return line 53 leads back to the working fluid reservoir 7, so that working fluid 8 can be returned from the third hydrogen reservoir 6 into the working fluid reservoir 7.

In the embodiment shown, the refueling system 1 has a (high-pressure) pump 46, which can be embodied in particular as an axial piston pump, radial piston pump, gear pump, or plunger piston pump. This high-pressure pump 46 serves to pump the working fluid from the working fluid reservoir 7 to the first hydrogen reservoir 4, from the first hydrogen reservoir 4 to the second hydrogen reservoir 5, from the second hydrogen reservoir 5 to the third hydrogen reservoir 6, and from the third hydrogen reservoir 6 back to the working fluid reservoir 7. The high-pressure pump 46 is connected to a drive 47. In the embodiment shown, the drive 47 is connected to a hydraulic connection 48 of the vehicle 2. A feed hose 50 is connected to the drive 47 via a bidirectional hydraulic coupling 49. If hydraulic fluid is conveyed via the drive 47, the drive 47 converts the volume flow into mechanical work and thereby in turn drives the high-pressure pump 46. The hydraulic flow expanded after the work has been performed is transferred via a return hose 51 to the bidirectional hydraulic coupling 49 and finally to the hydraulic connection 48.

The valves described above can be transferred magnetically, hydraulically or pneumatically, i.e. in particular between an open and a closed position. Pneumatic actuation of the valves is particularly preferred. In this embodiment, a compressed air compressor 56 may be provided, which supplies the supply air for switching the pneumatically actuated valves. An electrical unit 57 allows electrical energy to be stored and delivered to and from the drive 47 and the compressed air compressor 56.

The refueling system 1 also has an (electronic) control device 58, with which the above-described valves can be controlled, in particular opened and closed. The control device 58 has a timer 59 (described in more detail below).

With this refueling system 1, the vehicle 2 can be refueled with compressed gas, in this case hydrogen, as follows. At least the following steps are carried out.

In a first step, the first 4, second 5 and third hydrogen reservoir 6 are filled with the gas via the gas inlet 12.

In a further step, the refueling vehicle 3 with the refueling system 1 is brought to the place of use where the vehicle 2 to be refueled, for example an excavator, is parked.

In a further step, the vehicle 2 is connected to the refueling system 1 via the tank coupling 30.

In a further step, the drive 47 is supplied with energy via the hydraulic connection 48 or the electrical unit 57.

In a further step, the first hydrogen reservoir 4 is connected to the gas outlet 21 by opening the first gas outlet valve 22 by means of the control device 58, as a result of which hydrogen is transferred into the hydrogen tank of the vehicle 2 in a first outflow phase. The isentropic portion of the expansion in the first hydrogen reservoir 4 cools the hydrogen transferred to the vehicle 2. With the timer 59 of the control device 58, a waiting time from the opening of the first gas outlet valve 22 can be detected, so that a first post-compression phase by pumping working fluid 8 from the working fluid reservoir 7 into the first hydrogen reservoir 4 by means of the high-pressure pump 46 does not begin until after the beginning of the first outflow phase. Depending on the design, the first post-compression phase and the first outflow phase may temporally overlap in a time period selected from a range of 5 seconds to 4 minutes.

Before achieving a pressure equalization between the first hydrogen reservoir 4 and the vehicle 2 at the gas outlet 21, the valves are switched with the control device 58 in such a way that the first ejection connection 18 is shut off. Via the high-pressure pump 46 from the working fluid reservoir 7, working fluid 8 can still be fed into the first hydrogen reservoir 4 for a certain time (in particular until the start of the second outflow phase, see below).

In a further step, the second hydrogen reservoir 5 is connected to the gas outlet 21 by opening the second gas outlet valve 23 by means of the control device 58, so that a second outflow phase begins. With the timer 59 of the control device 58, a second waiting time can be maintained from the opening of the second gas outlet valve 23, so that a second post-compression phase by pumping working fluid 8 into the second hydrogen reservoir 5 by means of the high-pressure pump 46 only begins after the beginning of the second outflow phase. Depending on the design, the second post-compression phase and the second outflow phase may temporally overlap in a time period selected from a range of 5 seconds to 4 minutes.

Before achieving the pressure equalization between the second hydrogen reservoir 5 and the vehicle 2 at the gas outlet 21, the valves are switched by means of the control device 58 in such a way that the second ejection connection 19 is shut off. Via the high-pressure pump 46, working fluid 8 can still be fed from the first hydrogen reservoir 4 into the second hydrogen reservoir 5 for a certain time (in particular until the beginning of the third outflow phase, see below).

In a further step, the third hydrogen reservoir 6 is connected to the gas outlet 21 by opening the third gas outlet valve 24 by means of the control device 58, so that a third outflow phase begins. With the timer 59 of the control device 58, a third waiting time can be maintained from the opening of the third gas outlet valve 24, so that a third post-compression phase by pumping working fluid 8 into the third hydrogen reservoir 6 by means of the high-pressure pump 46 only begins after the beginning of the third outflow phase. Depending on the design, the third post-compression phase and the third outflow phase may temporally overlap in a time period selected from a range of 5 seconds to 4 minutes.

Before achieving the pressure equalization between the third hydrogen reservoir 6 and the vehicle 2 at the gas outlet 21, the valves are switched by means of the control device 58 in such a way that the third ejection connection 20 is closed.

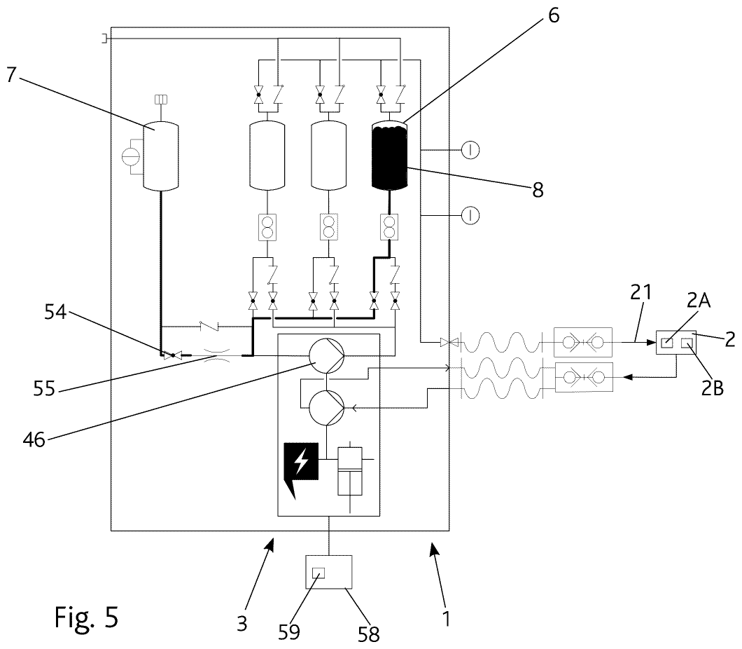

In a further step, cf. FIG. 5, the valves can be switched by means of the control device 58 in such a way that working fluid 8 is returned from the third hydrogen reservoir 6 into the working fluid reservoir 7.

Finally, by replenishing working fluid 8, the nominal or initial pressure in the first 4 and/or second 5 and/or third hydrogen reservoir 6 can be restored.

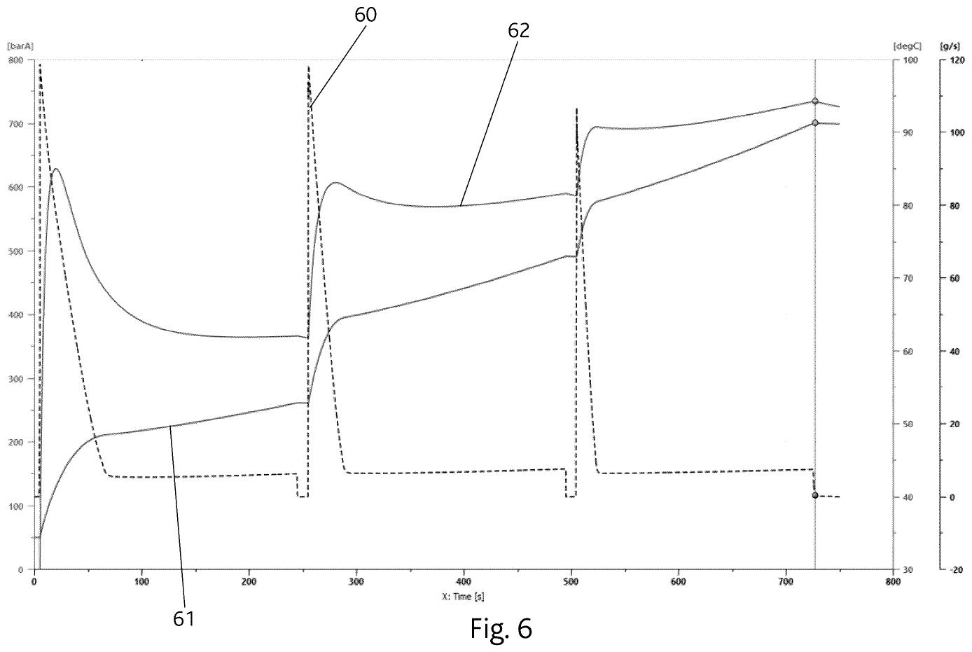

FIG. 6 shows a diagram with several characteristic curves in which the effect of the method described above is symbolically illustrated. A first characteristic curve 60 shows the mass flow of hydrogen in g/s. A second characteristic curve 61 shows the filling pressure of the hydrogen tank 2A in barA. A third characteristic curve 62 shows the temperature of the hydrogen tank 2A in ° C. At the beginning of the first outflow phase, the temperature in the hydrogen tank 2A rises rapidly until the temperature reaches a first (local) maximum. Then the cooling effect is due to the isentropic expansion of the hydrogen, which is particularly pronounced in the first outflow phase due to the high pressure difference between the inertial pressure of the first hydrogen reservoir 6 and the low initial pressure of the hydrogen tank 2A. In the second outflow phase and in the third outflow phase, significantly lower cooling occurs due to the isentropic expansion of the hydrogen. It is essential that the temperature in the hydrogen tank 2A does not rise (quasi) continuously during the refueling process, but that cooling occurs intermittently due to the isentropic expansion of the hydrogen, which contributes to maintaining the specified maximum temperature of the hydrogen in the hydrogen tank 2A of, for example, 110° C.

### REFERENCE NUMERALS

1 refueling system
2 vehicle
2A hydrogen tank
2B fuel cell
3 tank vehicle
4 first hydrogen reservoir
5 second hydrogen reservoir
6 third hydrogen reservoir
7 working fluid reservoir
8 working fluid
9 filling level measuring element
10 temperature measuring element
11 first injection connection
12 gas inlet
13 second injection connection
14 third injection connection
15 first gas inlet valve
16 second gas inlet valve
17 third gas inlet valve
18 first ejection connection
19 second ejection connection
20 third ejection connection
21 gas outlet
22 first gas outlet valve
23 second gas outlet valve
24 third gas outlet valve
25 common outlet line
26 temperature measuring element
27 gas pressure measuring element
28 tear-off protection
29 gas line
tank coupling
31 first inflow connection
32 second inflow connection
33 third inflow connection
34 first inflow valve
second inflow valve
36 third inflow valve
37 first inflow check valve
38 second inflow check valve
39 third inflow check valve
first return line
41 first return valve
42 second return line
43 second return valve
44 third return line
third return valve
46 high-pressure pump
47 drive
48 hydraulic connection
49 hydraulic coupling
feed hose
51 supply line
52 supply valve
53 return line
54 return valve
55 orifice
56 compressed air compressor
57 electrical unit
58 electronic control device
59 timer

1. A method for refueling a hydrogen tank with hydrogen, comprising the steps of:
providing a first hydrogen reservoir with a hydrogen-filled hydrogen volume,
providing a working fluid reservoir with a working fluid,
connecting the first hydrogen reservoir to the hydrogen tank so that hydrogen is transferred from the first hydrogen reservoir to the hydrogen tank in an outflow phase,
connecting the working fluid reservoir to the first hydrogen reservoir, so that working fluid is pumped from the working fluid reservoir into the first hydrogen reservoir in a post-compression phase overlapping with the outflow phase, thereby reducing the hydrogen-filled hydrogen volume in the first hydrogen reservoir, and
cooling the hydrogen in the first hydrogen reservoir by isentropic expansion before the post-compression phase and/or during the post-compression phase, so that hydrogen cooled by the isentropic expansion is transferred from the first hydrogen reservoir to the hydrogen tank, wherein the cooling of the hydrogen takes place during the transfer of hydrogen from the first hydrogen reservoir to the hydrogen tank.

2. The method according to claim 1, wherein a waiting time of at least 30 seconds is observed from connecting the first hydrogen reservoir to the hydrogen tank to connecting the working fluid reservoir to the first hydrogen reservoir.

3. The method according to claim 1, wherein the working fluid in the first hydrogen reservoir is in direct contact with the hydrogen.

4. The method according to claim 3, wherein a polyalphaolefin is used as the working fluid.

5. The method according to claim 1, wherein the hydrogen is present in the first hydrogen reservoir before being connected to the hydrogen tank at a nominal pressure of more than 500 bar and/or less than 875 bar.

6. The method according to claim 1, comprising:
providing a second hydrogen reservoir with a hydrogen-filled hydrogen volume,
connecting the second hydrogen reservoir to the hydrogen tank so that hydrogen is transferred from the second hydrogen reservoir to the hydrogen tank in a second outflow phase,
replenishing of working fluid into the second hydrogen reservoir in a second post-compression phase temporally overlapping with the second outflow phase, so that the hydrogen in the second hydrogen reservoir is cooled by isentropic expansion before the second post-compression phase and/or during the second post-compression phase, and cooled hydrogen is transferred by the isentropic expansion from the second hydrogen reservoir into the hydrogen tank.

7. The method of claim 6, comprising:
providing a third hydrogen reservoir with a hydrogen-filled hydrogen volume,
connecting the third hydrogen reservoir to the hydrogen tank so that hydrogen is transferred from the third hydrogen reservoir to the hydrogen tank in a third outflow phase,
replenishing of working fluid into the third hydrogen reservoir in a third post-compression phase temporally overlapping with the third outflow phase, so that the hydrogen in the third hydrogen reservoir is cooled by isentropic expansion before the third post-compression phase and/or during the third post-compression phase, and cooled hydrogen is transferred by the isentropic expansion from the third hydrogen reservoir into the hydrogen tank.

8. The method according to claim 1, wherein the working fluid is pumped by means of a high-pressure pump from the working fluid reservoir to the first hydrogen reservoir.

9. The method according to claim 8, wherein the high-pressure pump is coupled to a drive.

10. The method according to claim 9, wherein the drive is coupled to a hydraulic connection of the vehicle, so that the drive is operated via the hydraulic connection of the vehicle.

11. The method according to claim 10, wherein the drive is connected to the hydraulic connection of the vehicle via a bidirectional hydraulic coupling, so that hydraulic fluid at high pressure is supplied to the drive and hydraulic fluid at low pressure is returned from the drive to the hydraulic connection of the vehicle.

12. A refueling system for refueling a hydrogen tank with hydrogen, comprising:
a first hydrogen reservoir containing the hydrogen,
a working fluid reservoir containing a working fluid,
a control device for controlling a first ejection connection for ejecting hydrogen from the first hydrogen reservoir to the hydrogen tank and for controlling an inflow connection between the working fluid reservoir and the first hydrogen reservoir,
a pump with which working fluid can be pumped from the working fluid reservoir to the first hydrogen reservoir,
wherein
the control device is configured to control the inflow connection and/or the pump in such a way that hydrogen in the first hydrogen reservoir is cooled by isentropic expansion and hydrogen cooled by the isentropic expansion is discharged from the first hydrogen reservoir via the first ejection connection into the hydrogen tank, wherein the cooling of the hydrogen takes place during the transfer of hydrogen from the first hydrogen reservoir to the hydrogen tank.

13. The refueling system according to claim 12, comprising:
a second hydrogen reservoir that is connectable to the hydrogen tank via a second ejection connection, and
a third hydrogen reservoir that is connectable to the hydrogen tank via a third ejection connection.

14. The refueling system according to claim 13, comprising:
a first gas outlet valve in the first ejection connection, and/or
a second gas outlet valve in the second ejection connection, and/or
a third gas outlet valve in the third ejection connection, and/or
a first inflow valve in the inflow connection from the working fluid reservoir to the first hydrogen reservoir, and/or
a second inflow valve in a second inflow connection from the working fluid reservoir to the second hydrogen reservoir, and/or
a third inflow valve in a third inflow connection from the working fluid reservoir to the third hydrogen reservoir, and/or
a first gas inlet valve for filling the first hydrogen reservoir with the hydrogen, and/or
a second gas inlet valve for filling the second hydrogen reservoir with the hydrogen, and/or
a third gas inlet valve for filling the third hydrogen reservoir with the hydrogen, and/or
a first return valve in a first return line from the first hydrogen reservoir to the second hydrogen reservoir for transferring working fluid from the first hydrogen reservoir to the second hydrogen reservoir, and/or
a second return valve in a second return line from the second hydrogen reservoir to the third hydrogen reservoir for transferring working fluid from the second hydrogen reservoir to the third hydrogen reservoir, and/or
a third return valve in a third return line from the third hydrogen reservoir to the working fluid reservoir for returning working fluid from the third hydrogen reservoir to the working fluid reservoir.

15. A refueling vehicle comprising a cargo space in which the refueling system according to claim 13 is accommodated.

16. The method according to claim 1, wherein the hydrogen tank is integrated into a vehicle.

17. The method according to claim 6, wherein replenishing the working fluid into the second hydrogen reservoir in the second post-compression phase temporally overlapping with the second outflow phase comprises connecting the second hydrogen reservoir to the first hydrogen reservoir.

18. The method according to claim 7, wherein replenishing the working fluid into the third hydrogen reservoir in a third post-compression phase temporally overlapping with the third outflow phase comprises connecting the third hydrogen reservoir to the second hydrogen reservoir.

19. The method according to claim 8, wherein the high-pressure pump is an axial piston pump, a radial piston pump, a gear pump, a displacement piston pump, or a plunger piston pump.

20. The refueling system according to claim 12, wherein the control device comprises a valve controller.
